(19) United States
(12) Patent Application Publication
(10) Pub. No.: US 2026/0313278 A1
(43) Pub. Date: Oct. 8, 2026

(54) EXTERIOR COMMUNICATION SYSTEM FOR MOBILITY VEHICLE

(71) Applicants: Hyundai Motor Company, Seoul (KR); Kia Corporation, Seoul (KR)

(72) Inventors: Dong Jin KIM, Hwaseong-Si (KR); Jae Ok LEE, Hwaseong-Si (KR); Hae Young KWON, Hwaseong-Si (KR)

(73) Assignees: Hyundai Motor Company, Seoul (KR); Kia Corporation, Seoul (KR)

(21) Appl. No.: 19/391,431

(22) Filed: Nov. 17, 2025

(30) Foreign Application Priority Data
Apr. 8, 2025 (KR) 10-2025-0045679

(51) Int. Cl. H04R 1/02; B60Q 1/50; B60Q 5/00; B60W 60/00; G06F 3/16; H04R 3/00; H04R 9/06; H04R 9/08; B60R 11/00; B60R 11/02

(52) U.S. Cl. CPC H04R 1/025; B60Q 1/50; B60Q 1/503; B60Q 5/00; B60W 60/001; G06F 3/165; H04R 3/00; H04R 9/06; H04R 9/08; B60R 2011/004; B60R 2011/0043; B60R 11/0223; B60R 11/0247; H04R 2430/01; H04R 2499/13

(57) ABSTRACT

Provided is an external communication system for a mobility vehicle, wherein a user inside the vehicle or a control center operating the vehicle may communicate with external command entities, such as individuals located outside the vehicle. A sound generator and a sound receiver, which are provided for call functionality, may be integrated with an external panel of the mobility vehicle or configured to serve as design elements so that the external appearance of the vehicle is not adversely affected. by ensuring high-quality voice communication, the system may effectively prevent inconvenience caused by degraded call quality.

### CROSS REFERENCE TO RELATED APPLICATION

The present application claims priority to Korean Patent Application No. 10-2025-0045679, filed Apr. 08, 2025, the entire contents of which are incorporated herein for all purposes by this reference.

### BACKGROUND

### Field of the Present Disclosure

The present disclosure relates to an external communication system for a mobility vehicle, which enables voice-based communication with the vehicle from outside thereof.

### Description of Related Art

In the case of a mobility vehicle, including automobiles and other types of vehicles, there may be situations in which communication is required between an occupant inside the vehicle and a person outside the vehicle. However, since the interior and the exterior of the mobility vehicle are typically configured to be acoustically and physically shielded, the occupant inside the vehicle may open a window or door to communicate with a person outside thereof. This results in issues such as discomfort due to significant temperature differences between the vehicle’s interior and exterior, or during inclement weather conditions, including rain or snow.

Furthermore, autonomous mobility vehicles are currently under development, and situations may arise in which communication with individuals outside the vehicle becomes necessary. However, opening a window or door to enable such communication may pose a potential security risk.

The foregoing description is disposed solely for facilitating an understanding of the background of the present disclosure, and is not to be construed as an acknowledgment or admission that the present disclosure forms part of the related art known to those skilled in the art.

### SUMMARY

Accordingly, the present disclosure has been made in view of the above issues. It is intended to provide an external communication system for a mobility vehicle, enabling a user inside the vehicle or a control center operating the vehicle to communicate with a person outside the vehicle.

The technical aspects to be achieved in the exemplary embodiments of the present disclosure are not limited to those mentioned above. Other technical aspects not explicitly stated will be apparent to those of ordinary skill in the relevant technical field from the description that follows.

In various aspects of the present disclosure, an external communication system for a mobility vehicle may be provided, the system including: a sound generator including a first vibration panel coupled with an external panel of the mobility vehicle, generating a sound through the first vibration panel; and a sound receiver including a second vibration panel coupled with the external panel of the mobility vehicle and spaced apart from the first vibration panel, receiving a sound through the second vibration panel.

In various aspects of the present disclosure, the sound generator and the sound receiver may be disposed adjacent to each other at a pillar or a garnish of the mobility vehicle.

In various aspects of the present disclosure, the sound generator and the sound receiver may be vertically disposed, with the sound generator positioned above the sound receiver in a height direction of the vehicle.

In various aspects of the present disclosure, on the external panel, a first housing portion, in which the sound generator may be accommodated, is formed, and the first vibration panel is coupled with the first housing portion, and an elastically deformable first coupling member may be disposed between the first vibration panel and the first housing portion so that the first vibration panel is disposed in the first housing portion with the first coupling member as a medium therebetween.

In various aspects of the present disclosure, on the external panel, a second housing portion, in which the sound receiver is accommodated, may be formed, and the second vibration panel may be formed to be coupled with the second housing portion, and an elastically deformable second coupling member may be disposed between the second vibration panel and the second housing portion so that the second vibration panel is disposed in the second housing portion with the second coupling member as a medium therebetween.

In various aspects of the present disclosure, the sound generator may include: a first coil; a first permanent magnet; and a first suspension, wherein the first suspension is configured to support the first vibration panel, and the first coil, which vibrates by the first permanent magnet, is connected to the first vibration panel, enabling generation of the sound.

In various aspects of the present disclosure, the sound receiver may include: a second coil; a second permanent magnet; and a second suspension, wherein the second suspension is configured to support the second vibration panel, and when the second coil vibrates along with the second vibration panel, a voltage signal is induced in the second permanent magnet, enabling reception of the sound.

In various aspects of the present disclosure, the sound receiver may include: an acoustic sensor; an output portion; and an actuator, wherein, when the acoustic sensor detects the sound, the output portion is configured to output the sound detected by the acoustic sensor as an audio signal, and the actuator is connected to the second vibration panel, vibrating the second vibration panel in accordance with the audio signal received from the output portion.

In various aspects of the present disclosure, the sound receiver may further include: an operation portion controlling whether the sound is received, wherein, when the operation portion is operated, generation of the sound through the sound generator is restricted, and the sound is received through the sound receiver.

In various aspects of the present disclosure, the sound generator may further include a first indicator that illuminates when the sound is generated, and the sound receiver may further include a second indicator that illuminates when the sound is received.

In various aspects of the present disclosure, the system may further include a controller configured to control a volume of the sound generated by the sound generator and a reception sensitivity of the sound receiver.

In various aspects of the present disclosure, when the controller receives input through a position-identification portion indicating that the mobility vehicle is located within a predefined noise-generating area, it may be configured to increase the volume of the sound generated by the sound generator and the reception sensitivity of the sound receiver.

In various aspects of the present disclosure, when the controller receives input through the position-identification portion indicating that the mobility vehicle has entered a region of adverse weather conditions, it may be configured to increase the volume of the sound generated by the sound generator and the reception sensitivity of the sound receiver.

In various aspects of the present disclosure, the controller may be configured to adjust the volume of the sound generated by the sound generator or the reception sensitivity of the sound receiver in accordance with a command entered within the mobility vehicle or a command input through the sound receiver.

In various aspects of the present disclosure, the mobility vehicle may be configured to be capable of autonomous driving and may be disposed with a detection portion for detecting surrounding objects, wherein, when a command entity communicating with the mobility vehicle is identified through the detection portion around the mobility vehicle, the mobility vehicle is configured to move so that the sound generator and the sound receiver face the command entity.

In various aspects of the present disclosure, the sound generator may be configured to generate a guiding sound when the mobility vehicle is unable to move toward the command entity, prompting the command entity to face the sound generator and the sound receiver.

In various aspects of the present disclosure, the mobility vehicle may be disposed with a display portion for transmitting messages to an outside, wherein when the command entity is identified around the mobility vehicle through the detection portion, the display portion is configured to indicate the locations of the sound generator and of the sound receiver.

As described above, according to the external communication system for a mobility vehicle of the present disclosure, a user inside the vehicle or a control center operating the vehicle may communicate with external command entities, such as individuals located outside the vehicle.

A sound generator and a sound receiver, which are provided for call functionality may be integrated with an external panel of the vehicle or configured to serve as design elements so that the external appearance of the vehicle is not adversely affected.

The effects that may be obtained from the exemplary embodiments of the present disclosure are not limited to those explicitly described above. Other effects not detailed will be apparent to those skilled in the art from the following description.

### BRIEF DESCRIPTION OF THE DRAWINGS

The above objectives, features, and advantages of the present disclosure, as well as other related aspects, will be more clearly understood from the following detailed description taken in conjunction with the accompanying drawings, in which:

FIG. 1 is a diagram illustrating a mobility vehicle according to an exemplary embodiment of the present disclosure;

FIG. 2 is a diagram illustrating an external communication system for the mobility vehicle according to an exemplary embodiment of the present disclosure;

FIG. 3 is a diagram illustrating a sound generator according to an exemplary embodiment of the present disclosure;

FIG. 4 is a diagram illustrating the sound generator disposed on an external panel according to an exemplary embodiment of the present disclosure;

FIG. 5 is a diagram illustrating a sound receiver according to an exemplary embodiment of the present disclosure;

FIG. 6 is a diagram illustrating the sound receiver disposed on the external panel according to an exemplary embodiment of the present disclosure;

FIG. 7 is a diagram illustrating a sound receiver according to another exemplary embodiment of the present disclosure;

FIG. 8 is a diagram illustrating an external communication system for a mobility vehicle according to another exemplary embodiment of the present disclosure;

FIG. 10 is a diagram illustrating control of a mobility vehicle in an external communication system for a mobility vehicle according to an exemplary embodiment of the present disclosure.

### DETAILED DESCRIPTION

In the following description of the embodiments included herein, detailed descriptions of known technologies related to the present disclosure may be omitted when they are deemed to obscure the essential features of the embodiments. Furthermore, the accompanying drawings are provided only to facilitate understanding of the embodiments included in the present specification and are not intended to limit the technical scope of the present disclosure. The spirit and scope of the present disclosure should be understood to encompass all modifications, equivalents, and substitutions that fall within the scope of the present disclosure. The present disclosure is not intended to limit the present disclosure to the described forms or specific fields of application. It is to be understood that various alternative embodiments and modifications, whether explicitly or implicitly disclosed, may be made. Those skilled in the art to which the present disclosure pertains will recognize that changes may be made to the form and details of the present disclosure without departing from the scope and spirit of the present disclosure.

The present disclosure is described with reference to certain exemplary embodiments. However, as will be understood by those of ordinary skill in the art to which the present disclosure pertains, various modifications and alternative implementations of the disclosed exemplary embodiments may be made without departing from the spirit and scope of the present disclosure. Accordingly, the following description should be regarded as illustrative and is intended to teach those skilled in the art how to make and use various embodiments within the scope of the present disclosure. The forms of the present disclosure illustrated and described herein are to be understood as exemplary. Equivalent elements, materials, processes, or steps may be substituted for those specifically illustrated and described herein. Terms such as "including," "comprising," "incorporating," "consisting of," "having," and "is," as used in the present specification, are intended to be interpreted in a non-limiting manner. That is, such terms should be construed to include items, components, or elements not expressly listed. Furthermore, references to the singular form are to be understood as including the plural form as well, unless the context clearly dictates otherwise. Moreover, the various embodiments included in the present specification are to be understood as illustrative and descriptive, and are not intended to limit the scope of the present disclosure. All references to “joining” (for example, “attached,” “affixed,” “coupled,” “connected,” and the like) are provided solely to aid in the understanding of the present disclosure and are not intended to limit the positioning, orientation, use, or methods disclosed herein. Accordingly, references to joining are to be interpreted broadly. Furthermore, such references do not necessarily imply that two or more elements are directly connected to each other, unless explicitly stated otherwise. Additionally, all numerical terms or descriptors, such as “first,” “second,” “third,” “primary,” “secondary,” “major,” or any other general or ordinal terms, are to be understood solely as identifiers used to distinguish elements, configurations, variations, or modifications, and are not intended to indicate any order, priority, or preference among such elements. That is, these terms may be used to describe various components, but the components themselves are not to be limited by such descriptors. The present terminology is used solely to distinguish one element from another.

In the following description, suffixes such as "module" and "part" used in reference to components are provided solely for convenience and are used interchangeably without implying any distinct meaning or function.

When it is stated that a certain component is "connected" or "coupled" to another component, it should be understood that the connection or coupling may be direct or indirect, with other intervening components potentially present. In contrast, when a component is described as being "directly connected" or "directly coupled" to another component, it should be understood that no intervening components are present.

A controller may include a communication device for interacting with other controllers or sensors to control its assigned functions, a memory for storing operating systems, logic commands, and input/output information, and at least one processor for performing the judgment, computation, and decision-making required for such control.

The components may include any combination of the features described herein and may be arranged in any of the various configurations disclosed herein. The concepts relating to the structure and arrangement of the components disclosed herein, as well as their use and operation, may be applied to any number of embodiments in any combination, and are not limited to the specific embodiments discussed herein. Various embodiments including different features and configurations are described below with reference to the drawings.

Hereinafter, various embodiments included in the present specification will be described in detail with reference to the accompanying drawings. In the drawings, identical or similar components are denoted by the same reference numerals regardless of the figure in which they appear, and redundant descriptions thereof are omitted for clarity.

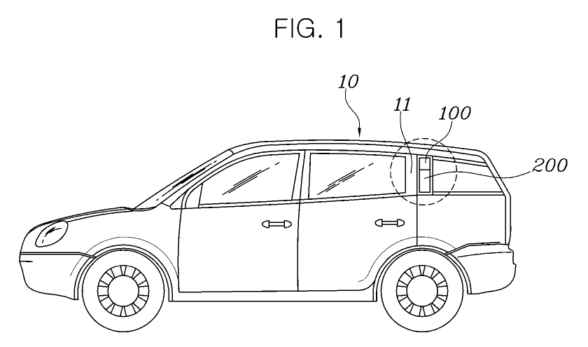

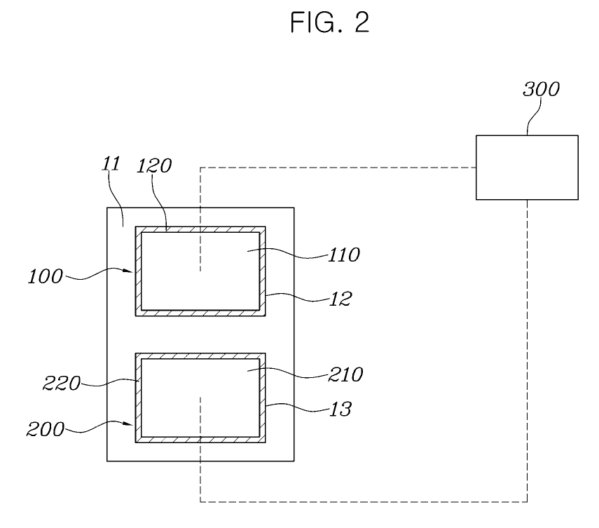

FIG. 1 is a diagram illustrating a mobility vehicle according to an exemplary embodiment of the present disclosure, and FIG. 2 is a diagram illustrating an external communication system for the mobility vehicle according to an exemplary embodiment of the present disclosure.

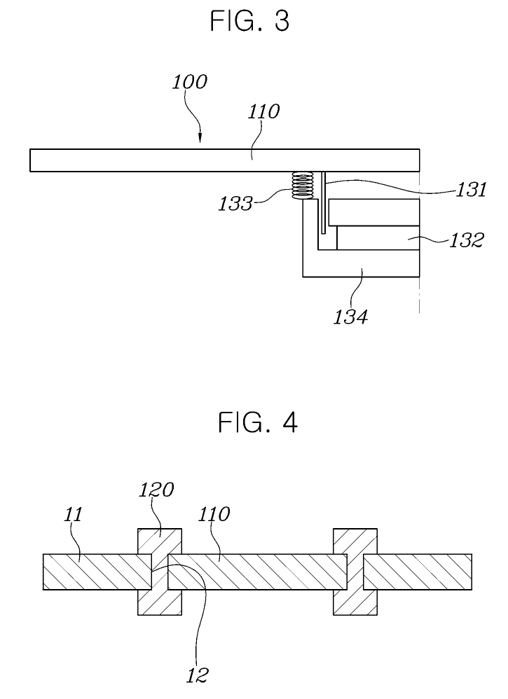

Furthermore, FIG. 3 is a diagram illustrating a sound generator according to an exemplary embodiment of the present disclosure, and FIG. 4 is a diagram illustrating the sound generator disposed on an external panel according to an exemplary embodiment of the present disclosure.

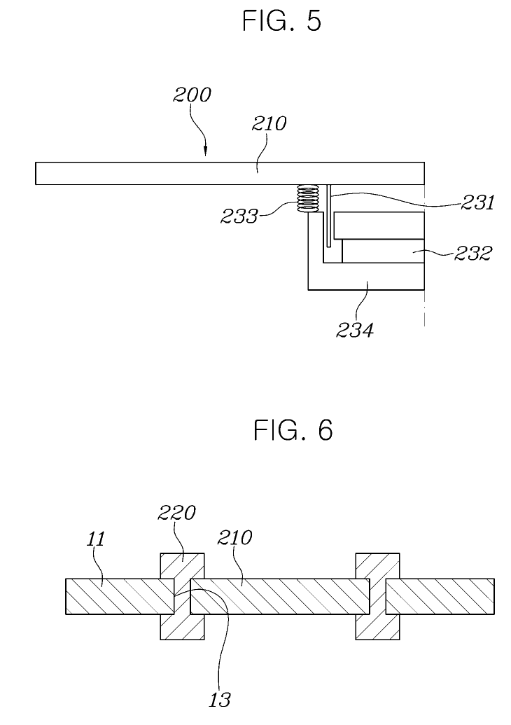

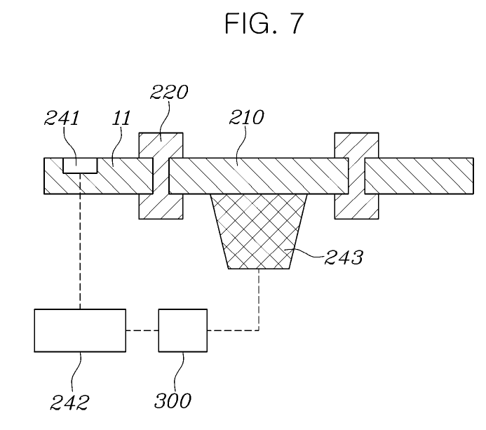

Furthermore, FIG. 5 is a diagram illustrating a sound receiver according to an exemplary embodiment of the present disclosure, FIG. 6 is a diagram illustrating the sound receiver disposed on the external panel according to an exemplary embodiment of the present disclosure, and FIG. 7 is a diagram illustrating a sound receiver according to another exemplary embodiment of the present disclosure.

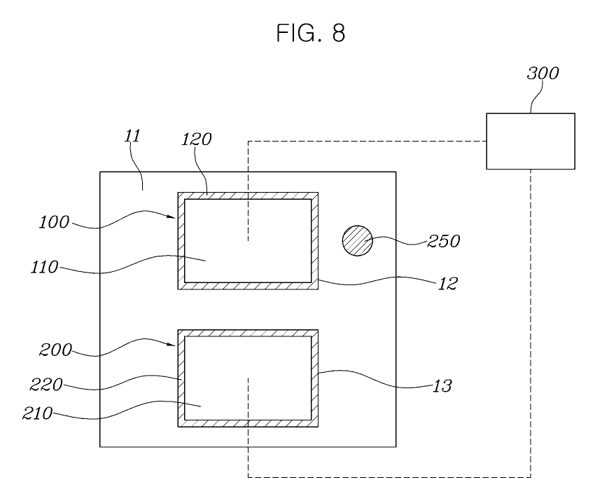

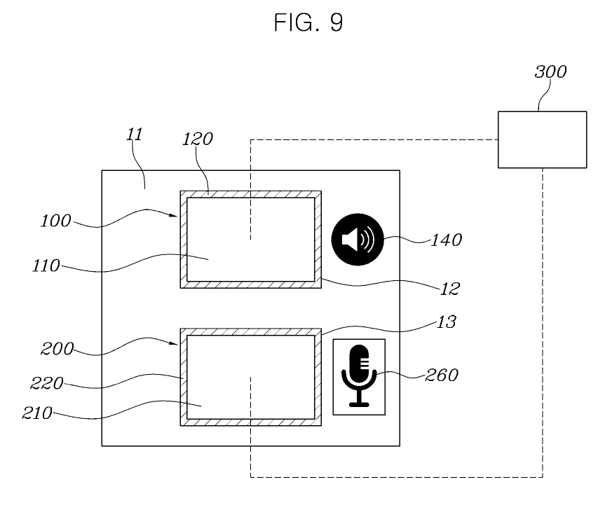

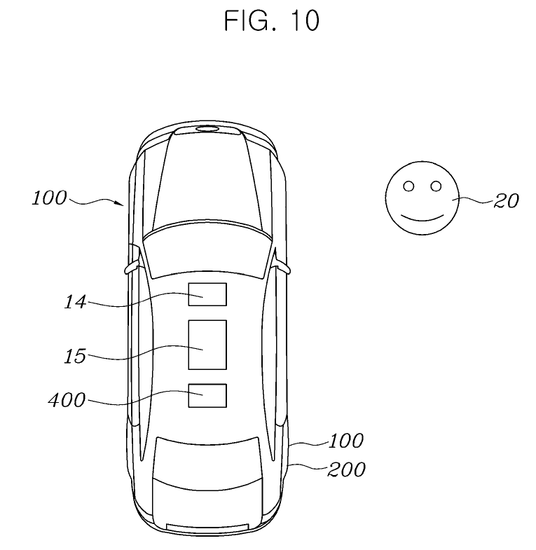

Meanwhile, FIG. 8 is a diagram illustrating an external communication system for a mobility vehicle according to another exemplary embodiment of the present disclosure, FIG. 9 is a diagram illustrating an external communication system for a mobility vehicle according to various exemplary embodiments of the present disclosure, and FIG. 10 is a diagram illustrating control of a mobility vehicle in an external communication system for a mobility vehicle according to an exemplary embodiment of the present disclosure.

The present disclosure enables communication between the mobility vehicle 10 and an external object, including a person; ensures that the components used for such communication do not adversely affect the exterior design elements of the mobility vehicle 10, and may ensure ease of use by maintaining communication quality.

To the present end, in an exemplary embodiment of the present disclosure, an external communication system for a mobility vehicle may include: a sound generator 100 disposed with a first vibration panel 110 coupled with an external panel 11 of the mobility vehicle 10, generating a sound through the first vibration panel 110; and a sound receiver 200 disposed with a second vibration panel 210 coupled with an external panel 11 of the mobility vehicle 10 and spaced apart from the first vibration panel 110, receiving a sound through the second vibration panel 210.

In an exemplary embodiment of the present disclosure, the mobility vehicle 10 may be a vehicle, but is not limited to this and may encompass various types of transportation means.

The mobility vehicle 10 is disposed with an external panel 11 designed to isolate and shield the interior from the exterior of the mobility vehicle 10. The external panel 11 may include various portions, such as fillers, doors, and garnish, and may be a portion exposed to the outside thereof. The sound generator 100 and the sound receiver 200 may be positioned on the exterior of the mobility vehicle 10, including components such as fillers, doors, and garnish. The sound generator 100 and the sound receiver 200 may be disposed adjacent to each other to enable sound-based communication with an external object. In an exemplary embodiment of the present disclosure, the command entity 20 may be a person, and the installation positions of the sound generator 100 and the sound receiver 200 may be determined based on the height of the person's face when standing. For example, the sound generator 100 and the sound receiver 200 may be positioned on the A-pillar, B-pillar, or C-pillar of the vehicle.

In an exemplary embodiment of the present disclosure, the sound generator 100 may be a speaker, and the sound receiver 200 may be a microphone.

Here, the sound generator 100 and the sound receiver 200 may be disposed vertically, with the sound generator 100 positioned above the sound receiver 200.

By positioning the sound generator 100 above, the sound generated by the sound generator 100 may be transmitted more widely. Additionally, by positioning the sound receiver 200 below, it may be placed closer to the user’s mouth, improving speech recognition accuracy. Furthermore, by vertically disposing the sound generator 100 and the sound receiver 200 apart from each other, it becomes easier to maintain a sufficient distance between them. The present configuration may help reduce howling or feedback noise caused by the sound being introduced into the sound receiver 200 while the sound is being directly transmitted to the user.

In an exemplary embodiment of the present disclosure, the sound generator 100 includes a first vibration panel 110, through which the sound generator 100 generates sound.

The first vibration panel 110 may be the same color as, or a different color from, the external panel 11 of the mobility vehicle 10, thereby serving as an exterior design element.

Additionally, the first vibration panel 110 may be designed to facilitate the transmission of sound characteristics and may be made of materials such as aluminum or titanium in a form of a thin membrane. Alternatively, the first vibration panel 110 may be made of plastic or reinforced plastic and may be made of the same material as the external panel 11.

The sound generator 100 may produce sound through the first vibration panel 110, which forms portion of the external panel 11 of the mobility vehicle 10, integrating the design element with the sound transmission function and reducing the required installation space.

In an exemplary embodiment of the present disclosure, as shown in FIG. 3, the sound generator 100 includes a first coil 131, a first permanent magnet 132, and a first suspension 133. The first suspension 133 disposed under the first vibration panel 110 supports the first vibration panel 110, and the first coil 131, which is vibrated by the first permanent magnet 132, may be connected to the first vibration panel 110 to generate sound.

The sound generator 100 functions as a speaker that converts electrical signals into sound and may include the first coil 131, first permanent magnet 132, first suspension 133, and first vibration panel 110. A first plate 134 may be disposed under the first vibration panel 110 to secure the first permanent magnet 132, and both the first plate 134 and the first suspension 133 may be fixed to a portion of the vehicle body beneath the first vibration panel 110.

The first suspension 133 elastically supports the first vibration panel 110, maintaining its position while allowing the first vibration panel 110 to vibrate. The first suspension 133 may include a spring, although other materials configured for providing elastic support to the first vibration panel 110 may also be used.

The first permanent magnet 132 forms a magnetic field around the first coil 131, and the first coil 131 is actuated by the present magnetic field. An alternating current AC may be applied to the first coil 131, and the application of the current may be controlled by the controller 300. The electrical signal transmitted by the controller 300 to generate sound may be amplified via an amplifier. Through the present configuration, the first permanent magnet 132 forms a magnetic field around the first coil 131, causing the first coil 131, and consequently the first vibration panel 110, to vibrate through interaction with the magnetic field.

Meanwhile, as illustrated in FIG. 4, a first housing portion 12, which accommodates the sound generator 100, may be disposed in the external panel 11, and the first vibration panel 110 may be configured to be coupled with the first housing portion 12.

That is, the first housing portion 12 may be formed as a hole penetrating through a portion of the external panel 11, and the first vibration panel 110 may be configured to be coupled with the internal contour of the first housing portion 12. In an exemplary embodiment of the present disclosure, the first housing portion 12 and the first vibration panel 110 are described as having a rectangular shape; however, various other shapes, including polygonal or circular configurations, may also be applied.

Here, a first coupling member 120 is disposed between the first vibration panel 110 and the first housing portion 12. The first coupling member 120 may be elastically deformable, allowing the first vibration panel 110 to be disposed into the first housing portion 12. It may be made of a rubber material and configured to surround the external edge portion of the first vibration panel 110 and the internal edge portion of the first housing portion 12, providing an airtight seal between them. Additionally, because the first coupling member 120 is elastically deformable, the first coupling member 120 enables the first vibration panel 110 to vibrate for sound generation while sealing the gap between the first vibration panel 110 and the external panel 11, thus preventing the ingress of foreign substances or moisture into the interior.

In an exemplary embodiment of the present disclosure, the sound receiver 200 includes a second vibration panel 210 configured to convert sound energy, generated by a user, into mechanical vibrations for sound reception.

In another exemplary embodiment of the present disclosure, the sound receiver 200 may utilize the second vibration panel 210 as a design element, with the panel also serving as an indicator that the user's voice is being recognized.

In the sound receiver 200 according to an exemplary embodiment of the present disclosure, the second vibration panel 210 may be disposed in the same color as, or in a different color from, the external panel 11 of the mobility vehicle 10, and may function as an exterior design element. Additionally, the second vibration panel 210 may be structured to convert sound energy from user-generated sound waves into mechanical vibrations and may be made of aluminum or titanium in a form of a thin diaphragm. Alternatively, it may be made of plastic, reinforced plastic, or the same material as the external panel 11.

The sound generator 200 may produce sound through the second vibration panel 210, which forms portion of the external panel 11 of the mobility vehicle 10, integrating the design element with the sound transmission function and reducing the required installation space。

In an exemplary embodiment of the present disclosure, as illustrated in FIG. 5, the sound receiver 200 includes a second coil 231, a second permanent magnet 232, and a second suspension 233. The second suspension 233 supports the second vibration panel 210, and when the second coil 231 vibrates together with the second vibration panel 210, a voltage signal is induced in the second coil 231 by the second permanent magnet 232, enabling sound reception.

The sound receiver 200 is configured to function as a microphone that converts sound waves into electrical signals, and may include the second coil 231, the second permanent magnet 232, the second suspension 233, and the second vibration panel 210.

A second plate 234 disposed under the second vibration panel 210 may be configured to secure the second permanent magnet 232, and both the second plate 234 and the second suspension 233 may be fixed to the vehicle body on the internal side of the second vibration panel 210.

The second suspension 233 elastically supports the second vibration panel 210, maintaining its position while allowing the second vibration panel 210 to vibrate. It may be formed of a spring, and in addition to a spring, various other materials capable of providing elastic support to the second vibration panel 210 may also be used.

The second vibration panel 210 vibrates in response to sound waves generated by the user's voice from outside, and the second coil 231, which is coupled with the second vibration panel 210 , vibrates along with the second vibration panel 210 .

The second permanent magnet 232 disposed under the second vibration panel 210 forms a magnetic field around the second coil 231, and when the second coil 231 vibrates within the magnetic field of the second permanent magnet 232, a voltage is induced. The induced voltage is received by the controller 300 operatively connected to the second coil 231 as an output signal, and is converted into an audio signal corresponding to the received sound. The output signal may be amplified or mixed via an amplifier or mixer. In the present manner, the sound receiver 200 may be configured to receive sound generated by the vibration of the second vibration panel 210 and the second coil 231 in response to sound waves. The second coil 231 may derive a voltage signal through interaction with the magnetic field of the second permanent magnet 232.

Meanwhile, as illustrated in FIG. 6, a second housing portion 13 may be formed in a portion of the external panel 11 to accommodate the sound receiver 200, and the second vibration panel 210 may be configured to be coupled with the second housing portion 13.

The second housing portion 13 may be formed as a through-hole in the external panel 11, and the second vibration panel 210 may be configured to be coupled with the internal contour of the second housing portion 13. In an exemplary embodiment of the present disclosure, the second housing portion 13 and the second vibration panel 210 may be formed in a rectangular shape; however, various shapes, including polygonal or circular forms, may also be applied. Additionally, the second housing portion 13 may be disposed adjacent to the first housing portion 12.

A second coupling member 220 may be disposed between the second vibration panel 210 and the second housing portion 13. The second coupling member 220 may be formed of an elastically deformable material to enable the second vibration panel 210 to be disposed in the second housing portion 13. The second coupling member 220 may be composed of a rubber material and may be configured to enclose the external periphery of the second vibration panel 210 and the internal periphery of the second housing portion 13, thereby sealing the interface between the second vibration panel 210 and the second housing portion 13. Furthermore, due to its elastic deformability, the second coupling member 220 may allow vibration of the second vibration panel 210 for sound reception, while also sealing between the interior and the exterior of the second vibration panel 210 to prevent the ingress of foreign substances or moisture.

In another exemplary embodiment of the present disclosure, the sound receiver 200 may include an acoustic sensor 241, an output portion 242, and an actuator 243.

As illustrated in FIG. 7, when the acoustic sensor 241 detects sound, the output portion 242 may output the detected sound from the acoustic sensor 241 as an acoustic signal, and the actuator 243, connected to the second vibration panel 210, may vibrate the second vibration panel 210 in accordance with the acoustic signal received from the output portion 242. Since the second vibration panel does not function as a microphone or speaker by itself, the output portion (242) may include a vibrator speaker having a vibrator, the vibrator being attached to the back of the second vibration panel 210 so that it can function as a microphone and speaker.

That is, in the exemplary embodiment of the present disclosure, the sound receiver 200 may detect sound through the acoustic sensor 241, convert the sound into an electrical signal, and the output portion 242 may amplify or remove noise from the electrical signal and output the electrical signal as an acoustic signal. The actuator 243 may include a small flat electromagnet coupled to the second vibration panel 210 to generate vibrations, and in response to a control signal from the controller 300 operatively connected to the actuator 243, vibrate the second vibration panel 210.

Accordingly, in another exemplary embodiment of the sound receiver 200, the sound may be received through the acoustic sensor 241 and output portion 242, and the actuator 243 is driven according to the signal corresponding to the received sound to vibrate the second vibration panel 210, indicating to the outside that the sound is being received.

Meanwhile, as illustrated in FIG. 8, the sound receiver 200 may further include an operation portion 250 configured to the sound reception.

The operation portion 250 may be implemented as a button-type or touch-type switch and may be disposed adjacent to the sound receiver 200 on the external panel 11 of the mobility vehicle 10.

The operation portion 250 may be disposed to prevent feedback noise or howling phenomena caused by the simultaneous operation of the sound generator 100 and the sound receiver 200. When the operation portion 250 is activated, sound generation through the sound generator 100 is restricted, and sound may be allowed to be received through the sound receiver 200.

Accordingly, when the operation portion 250 is directly operated from the exterior of the mobility vehicle 10, the user's intention may be reflected, and sound may be received via the sound receiver 200, enabling voice transmission. Additionally, since sound generation by the sound generator 100 is restricted, the accuracy of communication may be improved.

Here, the voice input received through the sound receiver 200 may originate from the interior of the mobility vehicle 10, a control center that controls the mobility vehicle 10, or the mobility vehicle 10 itself. Additionally, when it is stated that the sound generator 100 is restricted during the operation of the operation portion 250, this includes both muting the sound and reducing the volume.

Meanwhile, as illustrated in FIG. 9, the sound generator 100 may further include a first indicator 140 which illuminates when sound is generated, and the sound receiver 200 may further include a second indicator 260 which illuminates when sound is received.

The first indicator 140 and the second indicator 260 may be implemented as LEDs configured to emit light. The first indicator 140 may be disposed adjacent to the sound generator 100 on an external panel 11 of the mobility vehicle 10, while the second indicator 260 may be disposed adjacent to the sound receiver 200 on the external panel 11 of the mobility vehicle 10.

Additionally, the first indicator 140 may light up when sound is generated by the sound generator 100 and may take the form of an image resembling a speaker. Similarly, the second indicator 260 illuminates when sound is received by the sound receiver 200 and may take the form of an image resembling a microphone.

Thus, when sound is generated by the sound generator 100, the first indicator 140 illuminates, and when sound is received by the sound receiver 200, the second indicator 260 illuminates, allowing a user to recognize the timing of speech and reception externally, enabling smoother communication.

Meanwhile, under the control of the controller 300, the volume of sound generated by the sound generator 100 and the sensitivity of sound received by the sound receiver 200 may be controlled.

The volume of the sound generated by the sound generator 100 and the sensitivity of sound reception by the sound receiver 200 may be directly adjusted within the mobility vehicle 10 or automatically adjusted based on the control of the controller 300.

The controller 300 may be configured for controlling not only the sound generator 100 and the sound receiver 200, but also the overall operation of the mobility vehicle 10, and may be configured for controlling various components of the mobility vehicle 10 based on data obtained from various sensors disposed in the mobility vehicle 10 or through communication with external devices.

The controller 300 may adjust the volume of the sound generator 100 and/or the sensitivity of the sound receiver 200 in response to commands input through operations performed inside the mobility vehicle 10 or to commands received via the sound receiver 200. That is, when an occupant is present inside the mobility vehicle 10, the occupant may directly adjust the volume of the sound generator 100 and/or the sensitivity of the sound receiver 200 to improve communication quality with users outside the mobility vehicle 10. Furthermore, when a user outside the mobility vehicle 10 delivers a voice command through the sound receiver 200, the controller 300 may adjust the volume of the sound generator 100 and/or the sensitivity of the sound receiver 200. When the mobility vehicle 10 operates in autonomous driving mode, the control center responsible for the operation of the mobility vehicle 10 may adjust the volume of the sound generator 100 and/or the sensitivity of the sound receiver 200.

Additionally, when the controller 300 receives input from the position-identification portion 400 indicating that the mobility vehicle 10 is located within a predefined noise generation area, the controller 300 may increase the volume of the sound generator 100 or the sensitivity of the sound receiver 200.

The position-identification portion 400 may include various means for identifying the current location of the mobility vehicle 10, such as Global Positioning System (GPS) and communication with a control center. The controller 300 determines whether the mobility vehicle 10 is located within a predefined noise generation area based on the location information received from the position-identification portion 400. The noise generation area may include, for example, downtown areas or construction sites, and may be defined based on various factors including at least one of the surrounding environment, population density, and regional characteristics.

Accordingly, when the controller 300 determines that the mobility vehicle 10 has entered a noise generation area, it may increase a sound output level of the sound generator 100 and a sound reception sensitivity of the sound receiver 200, ensuring effective communication between a user located outside the mobility vehicle 10 and the mobility vehicle 10 itself, even in environments with high noise levels.

Additionally, the controller 300 may identify a noise level in the vicinity of the mobility vehicle 10, and further adjust the sound output level of the sound generator 100 and the sound reception sensitivity of the sound receiver 200 based on the identified noise level. The noise level around the mobility vehicle 10 may be determined based on external sound input received through the sound receiver 200, and various alternative methods may also be applied to determine the surrounding noise level.

When the controller 300 receives input from the position-identification portion 400 indicating that the mobility vehicle 10 has entered an area with adverse weather conditions, it may increase the sound output level of the sound generator 100 and the sound reception sensitivity of the sound receiver 200.

An area with adverse weather conditions may include environmental factors such as rain or snowfall. Accordingly, when it is determined that the mobility vehicle 10 has entered an area with adverse weather conditions though the position-identification portion 400, the controller 300 may increase the sound output level of the sound generator 100 and the sound reception sensitivity of the sound receiver 200, ensuring effective communication between the user located outside the mobility vehicle 10 and the mobility vehicle 10 itself, even in the presence of noise caused by rain or snowfall.

Meanwhile, the mobility vehicle 10 may be configured to enable autonomous driving and may be disposed with a detection portion 14 configured to detect objects in the vicinity. The detection portion 14 may be implemented as a camera, and various other detection means, such as lasers or LiDAR, may also be applied to detect objects around the mobility vehicle 10.

As illustrated in FIG. 10, when the controller 300 detects a command entity 20 communicating with the mobility vehicle 10 via the detection portion 14, the controller 300 may move the mobility vehicle 10 so that the sound generator 100 and the sound receiver 200 face the command entity 20.

Since the sound generator 100 and the sound receiver 200 are fixed in position on the mobility vehicle 10, the closer the sound generator 100 and the sound receiver 200 are to the command entity 20, i.e., the user, the higher the accuracy of sound transmission and reception is.

Accordingly, the controller 300 may identify the position of the user, who serves as the command entity 20, based on image information received through the detection portion 14. The controller 300 may then prompt the mobility vehicle 10 so that the sound generator 100 and the sound receiver 200 are positioned closer to the user.

Furthermore, when the mobility vehicle 10 is unable to move toward the command entity 20, the sound generator 100 may generate a guidance sound to prompt the command entity 20 to move closer to the sound generator 100 and the sound receiver 200.

That is, when the mobility vehicle 10 moves toward the command entity 20 (i.e., the user), the mobility vehicle 10 may experience difficulty in driving due to road conditions or the presence of surrounding obstacles. In such a case, the sound generator 100 may generate a guidance sound to prompt the user to move toward the mobility vehicle 10.

Furthermore, the mobility vehicle 10 may be disposed with a display portion 15 for delivering messages to the outside thereof, and when the command entity 20 is identified in the vicinity of the mobility vehicle 10 via the detection portion 14, the position of the sound generator 100 and the sound receiver 200 may be displayed via the display portion 15.

The display portion 15 may be disposed on the exterior of the mobility vehicle 10, including the roof, and may present visual information on its screen to help the user identify the mobility vehicle 10. Furthermore, by displaying messages via the display portion 15, the user may be prompted to identify the positions of the sound generator 100 and the sound receiver 200 on the external panel 11 of the mobility vehicle 10.

As a result, the command entity 20 may face the sound generator 100 and the sound receiver 200 disposed on the mobility vehicle 10, enabling accurate transmission and reception of communication sounds and improving the ease of use of the mobility vehicle 10.

According to the external communication system for the mobility vehicle disclosed herein, a user inside the mobility vehicle 10 or a control center operating the mobility vehicle 10 may communicate with the command entity 20, which may include a person located outside the mobility vehicle 10.

Additionally, the sound generator 100 and the sound receiver 200, which are disposed for voice communication, are either integrated with or designed as elements of the external panel 11 of the mobility vehicle 10, preserving the vehicle’s exterior design.

Furthermore, by ensuring high-quality voice communication, the system helps prevent user discomfort caused by poor call quality.

While specific embodiments of the present disclosure have been illustrated and described, it will be apparent to those skilled in the art that various modifications and changes can be made without departing from the technical spirit of the present disclosure, as defined by the claims set forth below.

What is claimed is:

1. An external communication system for a vehicle, the system comprising:
a sound generator including a first vibration panel coupled with an external panel of the vehicle, and generating a first sound through the first vibration panel; and
a sound receiver including a second vibration panel coupled with the external panel of the vehicle and spaced apart from the first vibration panel and receiving a second sound through the second vibration panel.

2. The system of claim 1, wherein the sound generator and the sound receiver are disposed adjacent to each other at a pillar or a garnish of the vehicle.

3. The system of claim 1, wherein the sound generator and the sound receiver are vertically disposed, with the sound generator positioned above the sound receiver in a height direction of the vehicle.

4. The system of claim 1,
wherein the external panel includes a first housing portion, in which the sound generator is accommodated, and the first vibration panel is coupled with the first housing portion, and
wherein an elastically deformable first coupling member is disposed between the first vibration panel and the first housing portion so that the first vibration panel is disposed in the first housing portion with the first coupling member as a medium therebetween.

5. The system of claim 1,
wherein the external panel includes a second housing portion, in which the sound receiver is accommodated, and the second vibration panel is coupled with the second housing portion, and
wherein an elastically deformable second coupling member is disposed between the second vibration panel and the second housing portion so that the second vibration panel is disposed in the second housing portion with the second coupling member as a medium therebetween.

6. The system of claim 1, wherein the sound generator comprises:
a first coil connected to the first vibration panel;
a first permanent magnet disposed adjacent to the first coil and vibrating the first coil, enabling generation of the first sound; and
a first suspension supporting the first vibration panel.

7. The system of claim 1, wherein the sound receiver comprises:
a second coil;
a second permanent magnet disposed adjacent to the second coil; and
a second suspension supporting the second vibration panel,
wherein based on that the second coil vibrates along with the second vibration panel, a voltage signal is induced in the second permanent magnet, enabling reception of the second sound.

8. The system of claim 1, wherein the sound receiver comprises:
an acoustic sensor;
an output portion; and
an actuator connected to the second vibration panel,
wherein, based on that the acoustic sensor detects the second sound, the output portion outputs the second sound detected by the acoustic sensor as an audio signal, and the actuator vibrates the second vibration panel in accordance with the audio signal received from the output portion.

9. The system of claim 1, wherein the sound receiver further comprises:
an operation portion controlling whether the second sound is received,
wherein, based on that the operation portion is operated, generation of the first sound through the sound generator is restricted, and the second sound is received through the sound receiver.

10. The system of claim 1,
wherein the sound generator further comprises a first indicator that illuminates based on that the first sound is generated, and
wherein the sound receiver further includes a second indicator that illuminates based on that the second sound is received.

11. The system of claim 1, further comprising:
a controller controlling a volume of the first sound generated by the sound generator and a reception sensitivity of the sound receiver.

12. The system of claim 11, wherein, based on that the controller receives input through a position-identification portion indicating that the vehicle is located within a predefined noise-generating area, the controller increases the volume of the first sound generated by the sound generator and the reception sensitivity of the sound receiver.

13. The system of claim 11, wherein, based on that the controller receives input through the position-identification portion indicating that the vehicle has entered a region of predetermined weather conditions, the controller increases the volume of the first sound generated by the sound generator and the reception sensitivity of the sound receiver.

14. The system of claim 11, wherein the controller adjusts the volume of the first sound generated by the sound generator or the reception sensitivity of the sound receiver in accordance with a command entered within the vehicle or a command input through the sound receiver.

15. The system of claim 1,
wherein the vehicle includes a detection portion for detecting surrounding objects,
wherein, based on that a command entity communicating with the vehicle is identified through the detection portion around the vehicle, the vehicle move under autonomous driving so that the sound generator and the sound receiver face the command entity.

16. The system of claim 15, wherein the sound generator generates a guiding sound based on that the vehicle is unable to move toward the command entity, thereby prompting the command entity to face the sound generator and the sound receiver.

17. The system of claim 15,
wherein the vehicle includes a display portion for transmitting messages to an outside, and
wherein based on that the command entity is identified around the vehicle through the detection portion, the display portion indicates locations of the sound generator and the sound receiver.

18. A vehicle comprising the external communication system of claim 1.
